(19) United States
(12) Patent Application Publication
(10) Pub. No.: US 2021/0116717 A1
(43) Pub. Date: Apr. 22, 2021

(54) SELECTIVELY RENDERING CONTENT

(71) Applicant: Hewlett-Packard Development Company, L.P., Spring, TX (US)

(72) Inventors: Kuan-Ting Wu, Taipei (TW); Cheng-Hua Yu, Taipei (TW); Chi-Hao Chang, Taipei (TW)

(73) Assignee: Hewlett-Packard Development Company, L.P., Spring, TX (US)

(21) Appl. No.: 17/042,982

(22) PCT Filed: Jun. 26, 2018
(86) PCT No.: PCT/US2018/039409

§ 371 Date: Sep. 29, 2020

(51) Int. Cl. G02B 30/26; G02B 26/08; G02B 3/00

(52) U.S. Cl. CPC G02B 30/26; G02B 3/005; G02B 3/0056; G02B 26/0875

(57) ABSTRACT

The present subject matter relates to techniques for selectively rendering content in 2D view and 3D view, for example, based on a choice of the user. In an example, a display may include a set of light sources and a 3D panel that may further include a 3D lens. In one example, the 3D lens may be selectively positionable in a first position where the 3D lens is positioned in a path of light emitted by the set of light sources.

### BACKGROUND

Displays are broadly categorized in two categories—first, displays that may render content, such as an image or a motion picture, to appear as two-dimensional (2D) when viewed, referred to as 2D displays, and second, referred to as three-dimensional (3D) displays, that may render content to appear as 3D. The 3D displays may employ various techniques to render the content in 3D view. For example, one type of 3D displays may employ specialized eye wear that may create depth perception for the user's eyes to render 3D images. In another example, 3D displays may employ a 3D display surface or volumetric display surfaces to present the 3D content. In further other example, 3D displays may employ a parallax barrier that may allow different content to reach the user's right and left eyes by selectively blocking portions of the content to create depth perception, thereby, making the user to perceive the content as 3D.

### BRIEF DESCRIPTION OF DRAWINGS

The detailed description is provided with reference to the accompanying figures. It should be noted that the description and the figures are merely examples of the present subject matter and are not meant to represent the subject matter itself.

FIG. 1 illustrates a schematic of a user device, according to an example.

FIG. 2 illustrates the user device including a light emitting panel and a 3D panel, according to an example.

FIG. 3A illustrates a front view of the light emitting panel when the 3D panel is not positioned in the path of the light emitted by the light emitting panel, according an example.

FIG. 3B illustrates a front view of the 3D panel positioned before the light emitting panel, according to an example.

FIG. 4 illustrates a display for selectively rendering the content in 3D, according to another example.

FIG. 5A illustrates a top of view of an assembly of the set of light sources and the frame illustrating the 3D lens in front of the set of light sources, according to an example.

FIG. 5B illustrates a top of view of the assembly of the set of light sources and the frame illustrating the 3D lens at the back front of the set of light sources, according to an example.

FIG. 6A illustrates a top of view of an assembly of the set of light sources and the frame illustrating the 3D lens in front of the set of light sources, according to an example.

FIG. 6B illustrates a top of view of the assembly of the set of light sources and the frame illustrating the 3D lens in side of the set of light sources, according to an example.

FIG. 7 illustrates an assembly illustrating relative positions of the 3D lenses and a set of light sources, according to an example.

FIG. 8 illustrates a light emitting unit for selectively rendering 3D content, according to an example.

### DETAILED DESCRIPTION

Generally, based on a type of content, different types of displays may be used to render either three-dimensional (3D) views or two-dimensional (2D) views. There may be instances where a portion of the content is to be rendered in 2D and another portion of the content is to be rendered in 3D. In other instances, the user may want to view the different contents selectively in 2D and 3D. In one example, the user may want to watch a motion picture in 3D while the user may want to see photos in 2D. However, a single display may be unable to provide such selective rendering of content. Accordingly, separate 2D display and 3D display may have to be used to render 2D content and the 3D content for viewing. The 3D display may provide 3D content, but the view of 3D display may not be scaled down to 2D. Similarly, the 2D display may provide 2D content, but the view of the current 2D displays may not be scaled to 3D. Moreover, providing 2D displays and 3D displays in a single unit may not be feasible operationally because the 3D display may not render the 2D content and the 2D display may not render 3D content. Even if the 2D displays and 3D displays are provided in a single unit, the single unit may be complex in design and operation. For instance, the single unit for rendering 2D and 3D may involve complex equipment and technologies which may be considerably high in cost.

The present subject matter relates to techniques for selectively rendering content in 2D view and 3D view, for example, based on a choice of the user. In an example, a display may include a set of light sources and a 3D panel that may further include a 3D lens. The technique may include selectively positioning the 3D lens with respect to the set of light sources in such a manner that the light from the set of light sources in certain cases may, and in certain other cases, may not pass through the 3D lens before reaching the user.

In an example, the 3D panel may include a frame such that the lens may be mounted on the frame. Further, the frame may be moveable with respect to the set of light sources to selectively position the 3D lens in a path of the light emitted from the set of light sources. In one example, the 3D lens may be positioned in the path of light emitted by the set of light sources to render 3D view. Alternatively, the 3D lens may be positioned such that the 3D lens may not be lie in the path of emitted light, to render the 2D view. Accordingly, in a first position, the 3D lens may be positioned with respect to the set of light sources such that the light emitted by the set of light sources may pass through the 3D lens. The 3D lens, by modifying the path of the light reaching the user, may create depth perception for the user thereby resulting in the 3D view. At a second position, the 3D lens may be positioned such that the 3D lens is no longer in the path of emitted light. As a result, the light from the set of light sources may reach the user without passing through the 3D lens thereby providing a 2D view,

In one example, the frame may include lateral walls such that one lateral wall may include the 3D lens mounted thereon. Further, for selectively positioning the 3D lens with respect to the set of light sources, the frame may be operably coupled to an actuator that may rotate the frame about an axis. Accordingly, the actuator may rotate the frame in such a way that the 3D lens may be selectively positioned with respect to the set of light sources to switch between the 2D view and the 3D view. In one example, the switching between 2D view and 3D view may be based on a selection made by the user. The user may operate the actuator to selectively position the 3D lens to change the rendered content in either the 2D view or the 3D view on the fly. In other words, the display may be changed to render the content in 2D and 3D while the set of light sources is continuously emitting light.

The technique of the present subject matter allows rendering of 2D views and 3D views from one display. In other words, single display may be used to render both the 2D content and 3D content. As a result, a need for separate displays for rendering 2D and 3D content may be alleviated. In addition, the display using the technique of the present subject matter is simple in design as the display using the techniques of the present subject may not need complex equipment and technologies that may be add considerably to the cost.

The above aspects are further described in conjunction with the figures, and in associated description below. It should be noted that the description and figures merely illustrate principles of the present subject matter. Therefore, various assembly that encompass the principles of the present subject matter, although not explicitly described or shown herein, may be devised from the description and are included within its scope. Additionally, the word “coupled” is used throughout for clarity of the description and can include either a direct connection or an indirect connection.

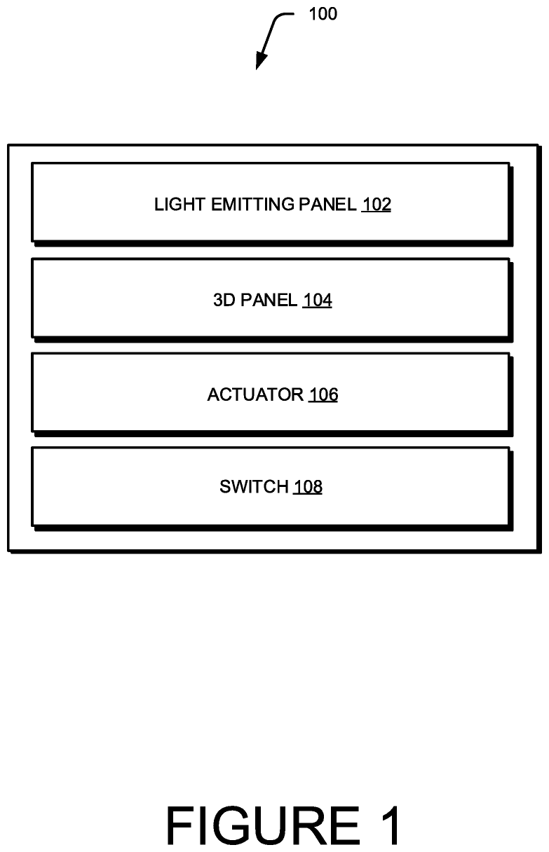

FIG. 1 illustrates a schematic of a user device 100, according to an example. As example, the user device 100 can be a television, laptop, desktop screen, mobile, or the like. The user device 100 may selectively render a content, such an image or a motion picture, to a user in two-dimensional (2D) view and three-dimensional (3D) view. Further, the content may be selective rendered in cases where still pictures, motion pictures, or video games may be presented in 3D while in other case, still pictures, motion pictures or video games may be presented in 2D. In one example, selective rendering may be done based on the user's selection.

The user device 100 may include a light emitting panel 102 and a 3D panel 104 that, in combination, may selectively render the content in two-dimensional (2D) and three-dimensional (3D). The light emitting panel 102 and the 3D panel may form a part of one example of a display (not shown) of the user device 100. The light emitting panel 102 may emit light to render the content. Further, the 3D panel 104 may be selectively positioned with respect to the light emitting panel 102 such that, in one case, the light coming from the light emitting panel 102 may pass through the 3D panel 104 to render the content in 3D, and other case, the light may reach the user without passing through the 3D panel 104 to render the content in 2D. Further, the 3D panel may be controlled based on user's selection to selectively render the content. For instance, the user may control the 3D panel 104 to selectively render the content when the user wants to watch the content in either 2D or 3D. The user may control the 3D content via different components of the user device 100.

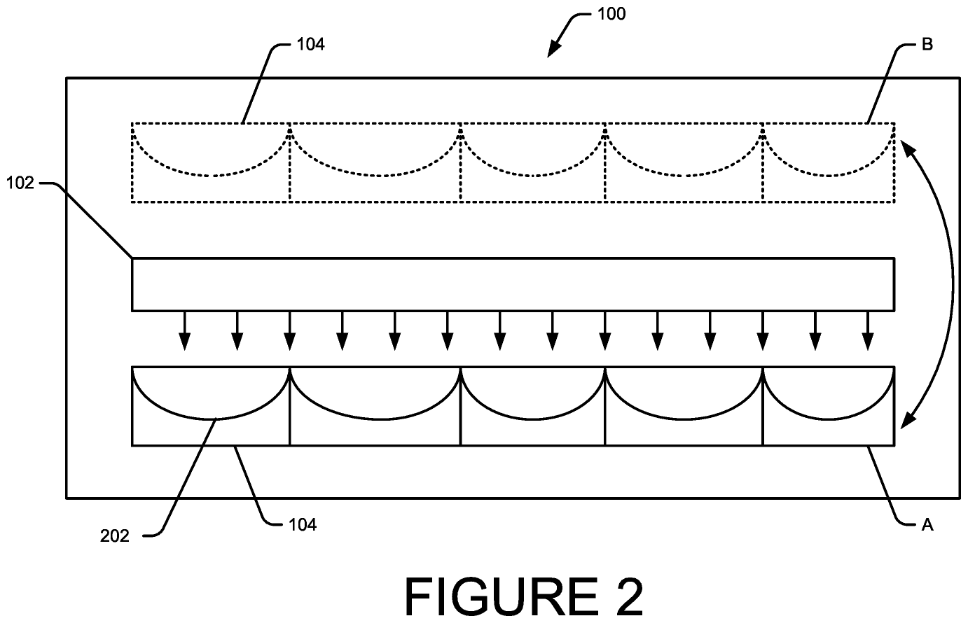

In one example, the user device 100 may also include an actuator 106 that may be coupled to the 3D panel to enable the 3D panel to render the content in 2D or 3D. In addition, the user device 100 may also include a switch 108 operable by the user to control the actuator 106 for controlling the 3D panel 104. In one example, the user may operate the switch 108 to actuate the actuator 106. In response, the actuator 106 may selectively position the 3D panel 104. The structure details of the light emitting panel and the 3D panel of the of the user device 100 may be explained in detail with respect to FIG. 2.

FIG. 2 illustrates the user device 100, according to an example. In one example, the user device 100 may include the light emitting panel 102 that may emit light to render the content to the user. The user device 100 may also include the 3D panel 104 positioned adjacent to emitted from the light emitting panel 102 to render the content in 3D. Further, the 3D panel 104 may include a plurality of 3D lenses 202. According to an aspect, the 3D panel 104 may be selectively positioned between a first position A and a second position B with respect to the light emitting panel 102. In the first position A of the 3D panel, each of the plurality of 3D lenses 202 may be positioned in such way that the 3D lenses 202 may be in a path of the emitted light to render the content in 3D. In the second position B, on the other hand, the 3D lenses 202 may be positioned in such a way that the 3D lenses 202 may be outside the path of the emitted light to render the content in 2D.

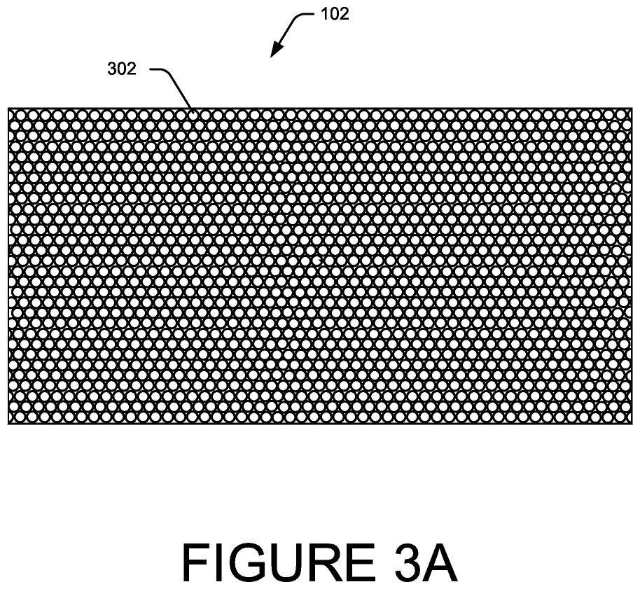

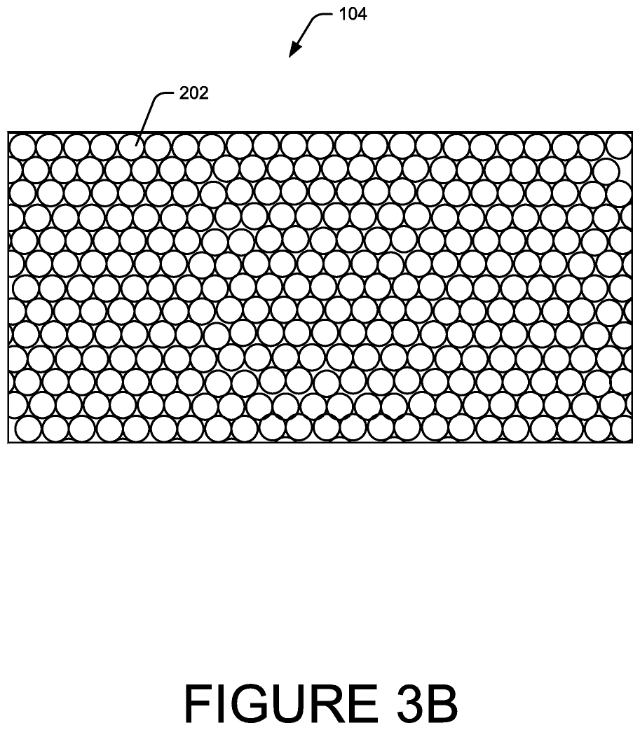

Accordingly, in one case, the complete 3D panel 104 may move relative to the light emitting panel 102. For example, the 3D panel 104 in the first position A may be positioned such that the complete 3D panel 104 is in the path of emitted light. In the second position B, in said example, the 3D panel 104 may be positioned such that the complete 3D panel 104 is outside the path of emitted light. For instance, the 3D panel 104 may move either in front or behind the light emitting panel 102. Examples of different relative positions of the 3D panel 104 and the light emitting panel are explained in detail with respect to FIGS. 3A and 3B respectively. In another case, the 3D panel 104 may be fixed with respect to the light emitting panel 102 while the 3D lenses may be positioned either in the path of emitted light or outside the path of emitted light. Accordingly, in the first position A of the 3D panel 104, the 3D panel 104 may remain stationary while the 3D lenses 202 may be positioned in the path of emitted light. Similarly, in the second position B of the 3D panel 104, the 3D lenses 202 may be positioned outside the path of emitted light. Therefore, the positions of the 3D panel 104, in the present case, are defined by the positions of the 3D lenses 202.

FIG. 3A illustrates a front view of the light emitting panel 102 when the 3D panel 104 is not positioned in the path of the light emitted by the light emitting panel 102, according an example. Accordingly, the light coming from the light emitting panel 102 is not altered by the 3D lenses 202 (as shown in FIG. 2) and the content is viewed by the user in 2D. As example, the light emitting panel 102 can be light emitting diode (LED) based, organic light emitting diode (OLED) based, and micro-light emitting diode (μLED) based. The light emitting panel 102 may formed of a plurality of set of light sources 302 arranged along a length of the light emitting panel 102. For instance, the set of light sources 302 may include a single light source and in another instance, may include multiple light sources. Further, the light source can be, but not limited to, a LED unit, OLED unit, μLED unit, or the like. In one example, the light emitting panel 102 may render the content in 2D. Although not shown, the light emitting panel 102 may receive a signal from an audio/video unit of the user device 100 for rendering the content. When the content is to be rendered in 3D instead, the 3D panel 104 may be positioned such that the light emitted by the light emitting panel 102 may be altered by the 3D panel 104 to render the content in 3D. A manner by which the content is rendered in 3D is explained with respect to FIG. 3B.

FIG. 3B illustrates a front view of the 3D panel 104 positioned in the path of the light emitted from the light emitting panel 102, according to an example. The 3D panel 104 includes a plurality of 3D lenses 202 that may be positioned in the path of the light such that the light coming from the light emitting panel may be altered thereby rendering the content in 3D. In one example, all the 3D lenses 202 may move together such that all the 3D lenses 202 may, at once, be positioned in path of the light. As mentioned before, the 3D panel may be actuated by the actuator 106 (shown in FIG. 2). In one example, the 3D lenses 202 may be actuated by the actuator 106 to selectively position the 3D lenses 202 in the path of light to alter their path.

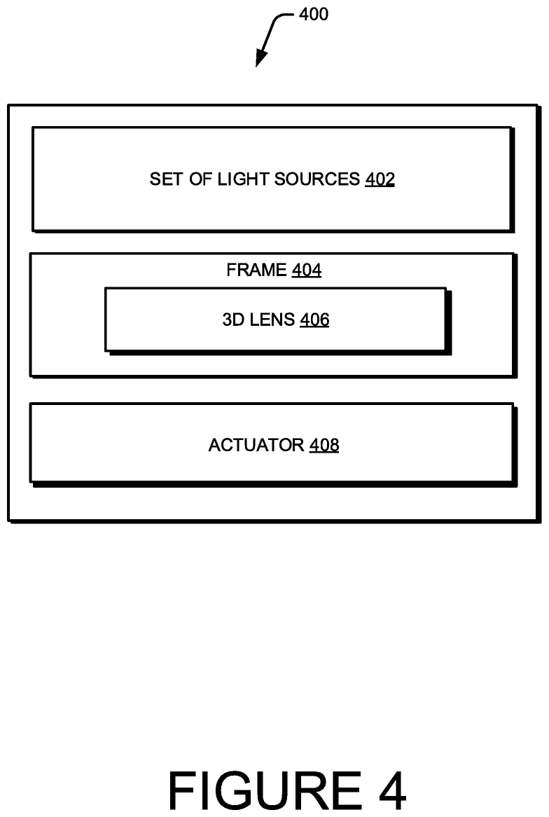

In one example, the content may also be rendered selectively by an assembly that includes a set of light sources, a frame including a 3D lens, and an actuator. An example of such an assembly may be explained in detail with respect to FIG. 4 onwards.

FIG. 4 illustrates a display 400 for selectively rendering the content in 3D, according to another example. The display 400 may include a set of light sources 402 that may emit light. The display 400 may also include a frame 404 that may be selectively positionable with respect to the set of light sources 402. The frame 404 may include a 3D lens 406 that can be selectively positioned with respect to the set of light sources. In one example, multiple frame 404 may be used to mount the 3D lenses 202 (shown in FIG. 2) of the 3D panel 104 (shown in FIG. 2).

In one example, the frame 404 may be positioned in a first position such that the 3D lens 406 may be positioned in a path of light. In another example, the frame 404 may be positioned in a second position such that the 3D lens 406 may be positioned outside the path of light.

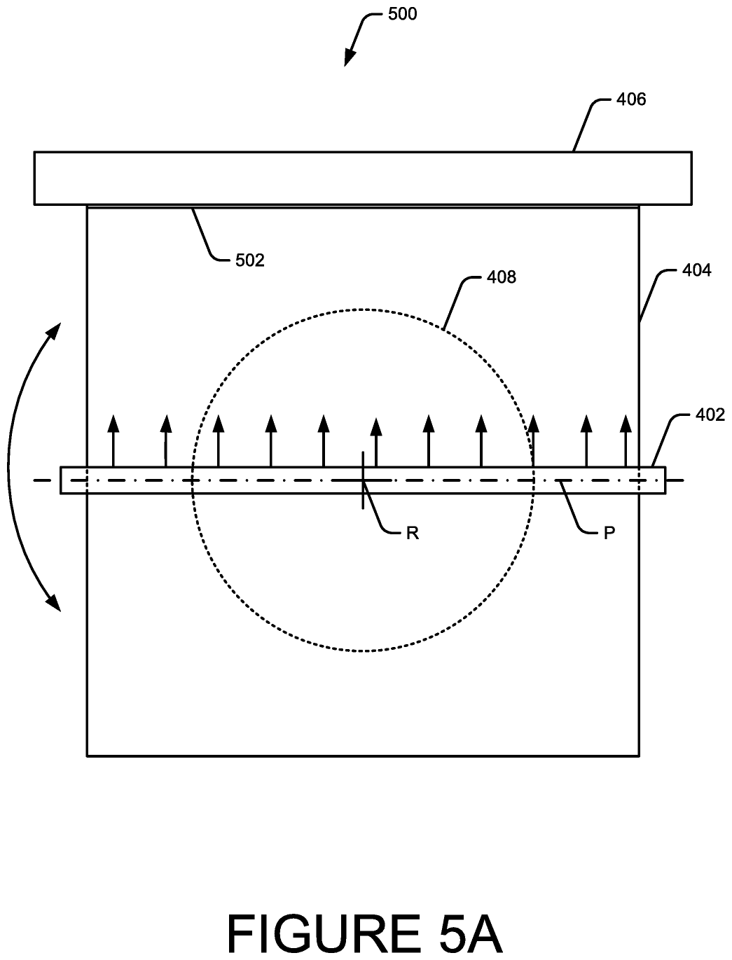

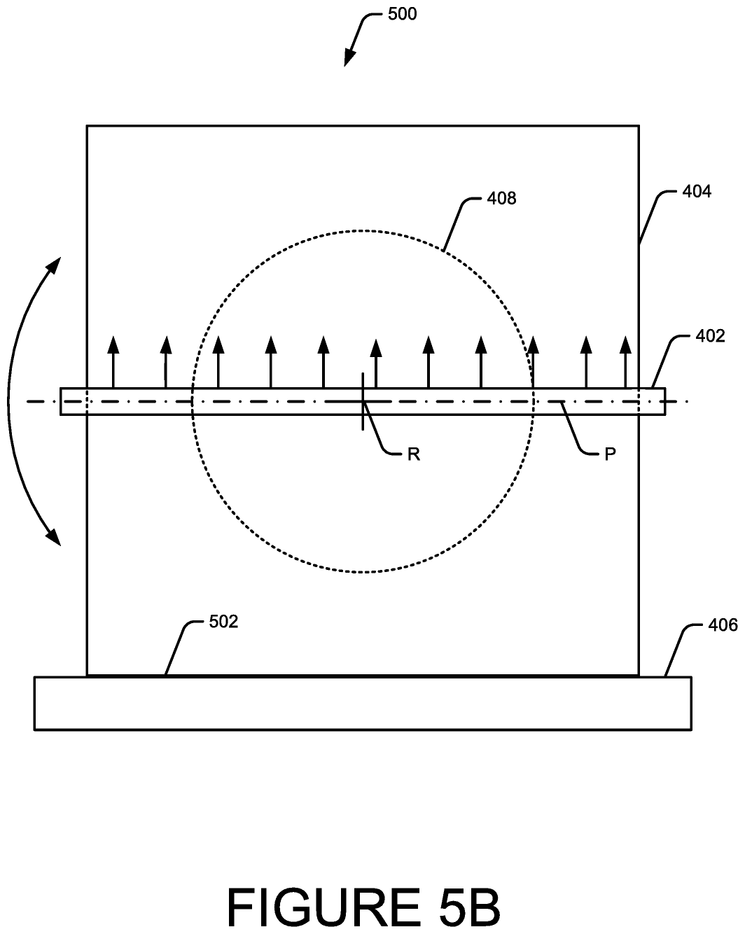

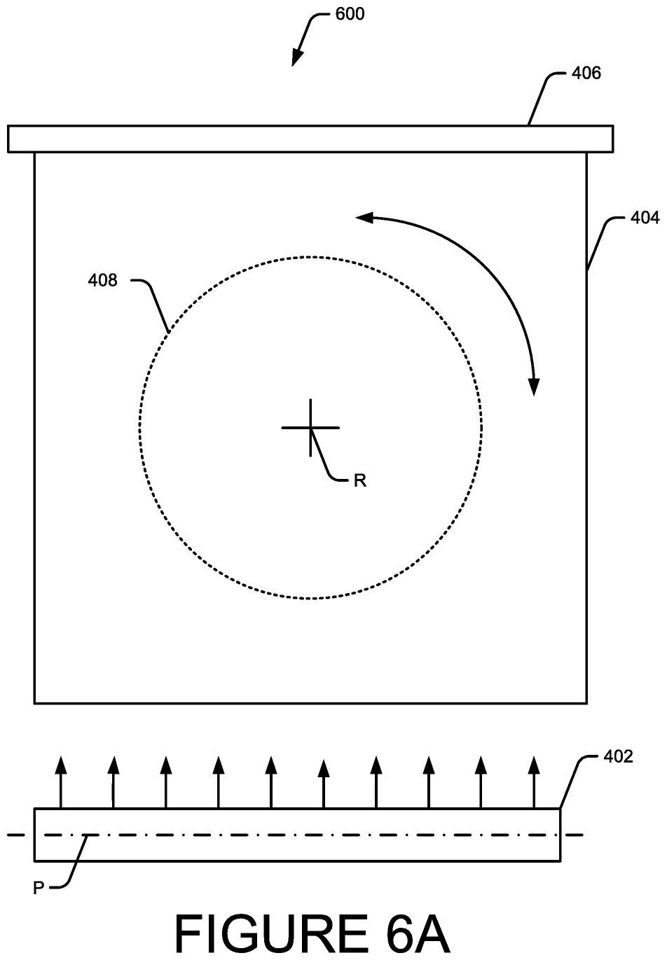

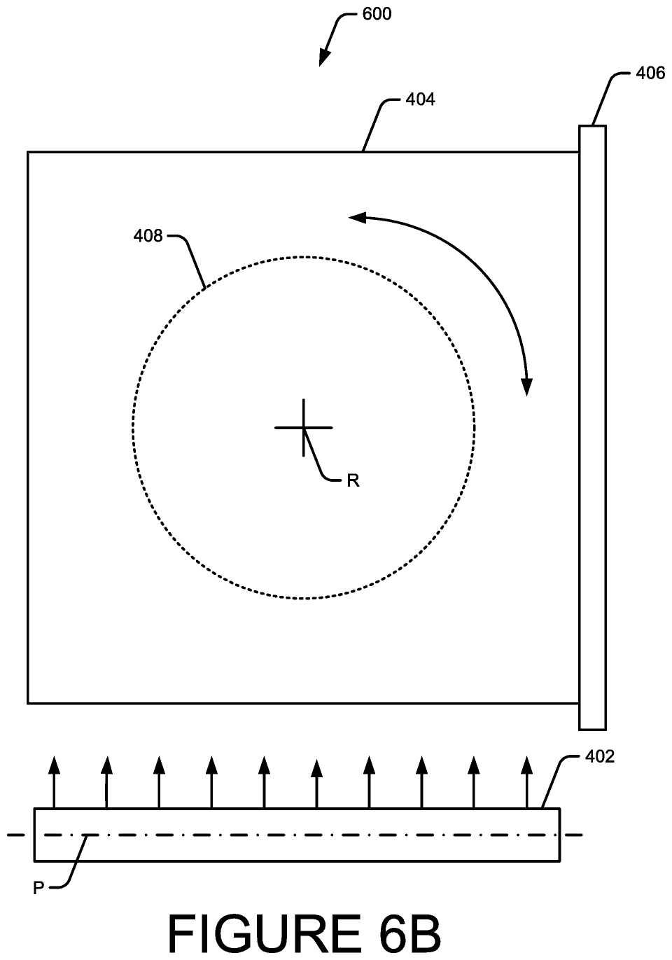

The display 400 may also include an actuator 408 that may actuate the frame to move with respect to the set of light sources 402. In one example, the actuator 408 can be an electric motor. Further, the actuator 408 may selectively position the frame 404 in the first position and the second position based on a selection by the user. The frame 404 and the set of light sources 402 can be relatively placed in different positions based on different factors, such as design of the display to be made or dimensions of the set of light sources 402, the frame 404, and the actuator 408. In one example, the frame 404 may be positioned below the set of light sources and the actuator 408 may be positioned below the frame 404. In another example, the frame 404 may be positioned before the set of light sources 402 and the actuator 408 may be positioned below the frame 404. An example of an assembly in which the frame 404 positioned below the set of light sources 402 is explained with respect to FIGS. 5A and 5B and another example of an assembly in which the frame 404 positioned in front of the set of light sources 402 is explained with respect to FIGS. 6A and 6B.

FIGS. 5A and 5B illustrates top views of an assembly 500 of the set of light sources 402 and the frame 404, illustrating their relative positions. FIG. 5A illustrates a top of view of the assembly 500 when the 3D lens 406 is in the first position, as described above, while FIG. 5B illustrates a top view of the assembly 500 when the 3D lens 406 is in the second position described above. In one example, the light emitted from the set of light sources 402 may be perpendicular to a plane P that may contain the set of light sources 402. In one case, as shown in FIG. 5A, the plane P may also contain the axis of rotation R. In such a case, as shown, the frame 404 may surround the set of light sources 402. For example, the frame 404 may be rotated by 180 degrees to position the 3D lens 406 either front or behind the set of light sources 402. Accordingly, the frame 404 may rotate about the set of light sources 402 to move the 3D lens 406 either in front of the set of light sources 402 or at back of the set of light sources 402.

Further, the actuator 408 may be positioned below the frame 404 and may be coupled to the frame 404 to rotate the frame 404. In one example, the actuator 408 may be positioned below the set of light sources 402. In one example, the actuator 408 may be positioned with respect to the frame 404 such that an axis of rotation of a shaft of the actuator 408 may be co-axial with the axis of rotation R of the frame 404. In another example, however, the axis of rotation of a shaft of the actuator 408 may not be co-axial with the axis of rotation R of the frame 404. For instance, the axis of rotation of a shaft of the actuator 408 may not be co-axial with the axis of rotation R of the frame 404 when the actuator 408 may be coupled to the lateral walls of the frames.

Although FIG. 5A illustrates the actuator 408 positioned below the frame 404 and the set of light sources 402, the actuator 408 may be positioned above the frame 404 and the set of light sources 402. In another example, as mentioned above, the actuator 408 may be coupled to one of the lateral walls of the frame 404 and, therefore, be on a side of the set of light sources 402 or in the same direction as the set of light sources 402. In one example, the actuator 408 may be coupled to a bottom wall (not shown) of the frame 404. In another example, the actuator 408 may be coupled to a top wall (not shown) of the frame 404, in case where the actuator 408 is positioned above the set of light sources 402s. In yet another example, the actuator 408 may be coupled to any of the wall of the frame 404 to rotate the frame 404.

According to an example, the actuator 408 may be coupled to the frame 404 through a driving mechanism. For example, the actuator 408 may be directly coupled to the frame 404 through a shaft. In another example, the actuator 408 may be coupled to the frame 404 through a drivetrain. As example, the drivetrain can be a gear transmission box, a belt drive, a chain drive. Although FIG. 5A illustrate single actuator coupled to the frame, there can be case where multiple frames may be coupled to single actuator such that the actuator rotates all the coupled frame at the same time. In another case, multiple actuators may be coupled to single frame such that multiple actuators may be operated together to rotate the frame with respect to the set of light sources 402.

In one example, the frame 404 may include a front wall 502 for mounting the 3D lens 406 on the frame 404. In one example, when the user operates the switch (as shown in FIG. 1) to view the content rendered as 3D content, the switch 108 may signal the actuator 408 to be activated. Accordingly, the actuator 408 may actuate the frame 404 and causes rotation of the frame 404 to position the 3D lens 406 in front the set of light sources 402. Alternatively, when the user operates the actuator 408 to view the in 2D, the user operates the switch 108 (as shown in FIG. 1) to signal the actuator 408. Accordingly, the actuator 408 may rotate the frame 404 to position the 3D lens 406 outside the path of light. In one example, the frame 404 may be rotated clockwise by 180 degrees to position the 3D lens 406 behind the set of light sources 402. An example of the 3D lens 406 positioned outside path of light from the set of light sources 402 is illustrated in FIG. 5B.

FIG. 5B illustrates a top view of the assembly 500 of the set of light sources 402 and the frame 404 depicting the second position of the 3D lens 406, according to an example. In the illustrated example, the frame 404 may be rotated by 180 degrees to position the 3D lens 406 behind the set of light sources 402. In other words, the 3D lens 406 may be positioned outside the path of light emitted by the set of light sources. Once the 3D lens 406 are outside the path of light, the light may reach the user's eye without any alteration thereby rendering the content in 2D.

Although FIGS. 5A and 5B illustrates the set of light sources and the axis of rotation R in the same plane P, there may be an example in which axis of rotation R of the frame 404 may positioned at an offset from the plane P. An example of such an assembly is explained with respect to FIGS. 6A and 6B.

FIGS. 6A and 6B illustrate top views of an assembly 600 of the light sources 402 and the frame 404 illustrating different relative positions of the light sources 402 and the frame 404, according to an example. FIG. 6A illustrates a top of view of the assembly 600 when the 3D lens 406 is in the first position while FIG. 6B illustrates a top view of the assembly 600 when the 3D lens 406 is in the second position. As illustrated in FIG. 6A, the frame 404 may be positioned in front of the light sources 402 such that the plane P containing the set of light sources 402 may not contain the axis of rotation of the frame 404. Further, the frame 404 may include the 3D lens 406 and may be coupled to the actuator 408. The actuator 408 may be positioned such that an axis of rotation of a shaft of the actuator 408 and the axis of rotation R of the frame 404 are co-axial. In another case, the axis of rotation of the shaft of the actuator 408 and the axis of rotation R of the frame 404 may not be co-axial. The actuator 408 can be positioned with respect to the frame 404 in different ways as mentioned with respect to FIG. 5. In one example, the actuator 408 may be positioned lower than the set of light sources 402. Further, the axis of rotation of the shaft of the actuator 408 and the axis of rotation R of the frame 404 may not co-axial. FIG. 6A illustrates the first position in which the 3D lens is positioned in the path of light emitted from the set of light sources 402. The light emitted from the set of light sources 402 may be altered by the 3D lens to render the content in 3D. Further, the 3D lens may be repositioned such that the 3D lens is not in the path of the emitted light. An example of such a position is illustrated in FIG. 6B.

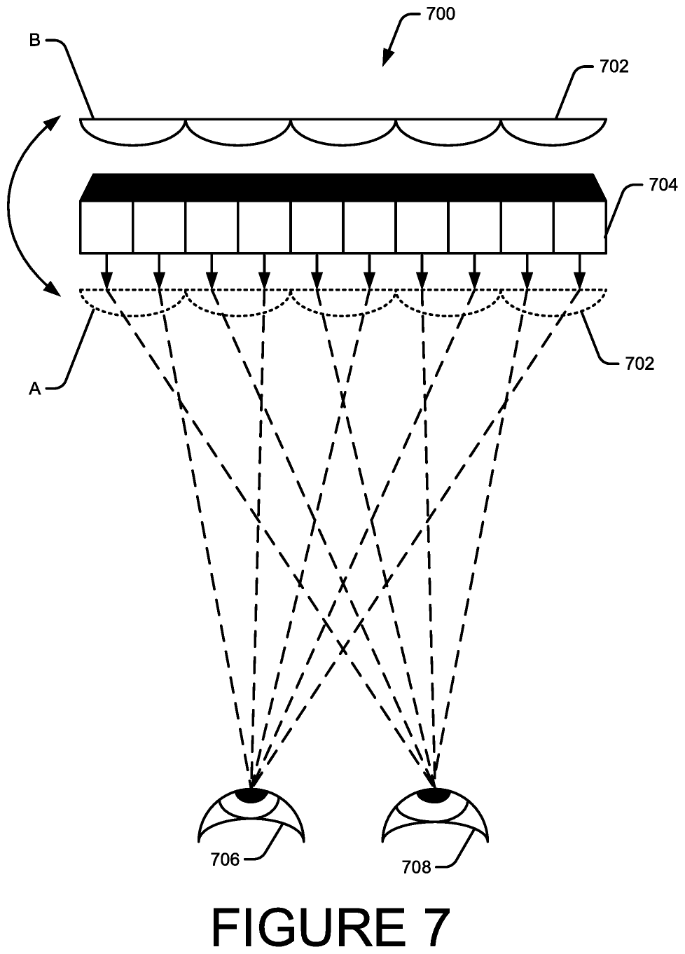

FIG. 6B illustrates the 3D lens 406 positioned in the second position, according to an example. The actuator 408 may be actuated to rotate the frame 404 by 90 degree such that the 3D lens is no longer in the path of the emitted light. Accordingly, the light passing from the set of light sources may reach the user without being altered by the 3D lens. An example of how the 3D lens 406 alter the light is explained in detail with respect to FIG. 7.

FIG. 7 illustrates an assembly 700 showing relative position of 3D lenses 702 with respect to a set of light sources 704, according to an example. As mentioned before, the 3D lenses 702 are selectively positionable in the first position A and in the second position B. In the first position A, the 3D lenses 702 may be positioned in path of the light emitted by the set of light sources 704, and in the second position B, the 3D lenses 702 may be positioned outside the path of light. An example of 3D lenses 702 positioned in front of a set of light sources 704 to alter a path of light emitted by the set of light sources, is illustrated. In the illustrated example, the 3D lenses 702 can be lenticular lens that may alter the path of the light. In one example, the rays of light coming from the set of the light sources 704 may pass through the 3D lenses 702. As the light passes through the 3D lenses 702, a portion of the ray of light may be refracted at an angle towards a user's left eye 706 and another portion of the light may be refracted at another angle the user's right eye 708. Further, as the both portion of the ray of light reaches user's eye at different angles, a parallax may be formed. Further, the parallax may create depth perception for the user's eyes. This depth perception causes the user's eye to see the light in 3D.

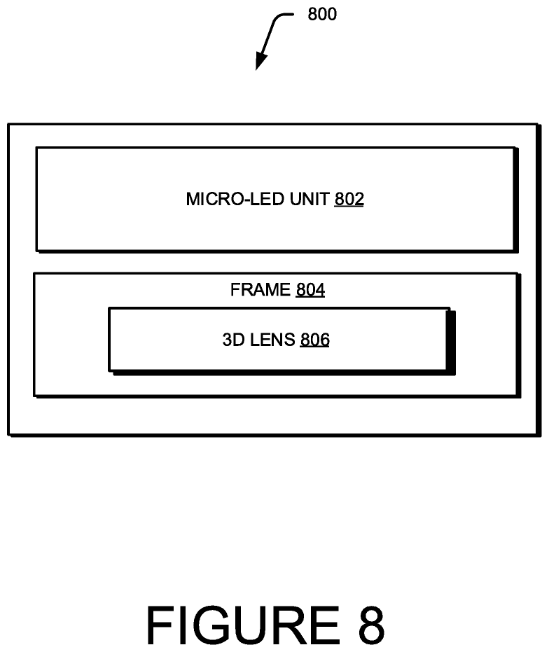

In one example, the display 400 may be formed of numerous replaceable light emitting units. In one example, the light emitting unit of the display 400 may be replaced with another light emitting unit in case the light emitting unit does not work. An example of such a light emitting unit is explained in detail with FIG. 8.

FIG. 8 illustrates the light emitting unit 800 for selectively rendering 3D content, according to an example. The light emitting unit 800 may include a micro-LED (μLED) unit 802 that may emit light. In one example, the μLED unit 802 can be a red-green-blue (RGB) μLED unit. The light emitting unit 800 may also include a frame 804 that may be coupled to the μLED unit 802 such that the frame 804 can move around with respect to the light emitting unit 800. The frame 804 may include a 3D lens 806 that may be selectively movable to different position for selectively positioning the 3D lens 806. In one example, the frame 804 may be movable to a first position where the 3D lens 806 may be positioned in a path of light emitted from the μLED unit 802. In other example, the frame 804 may be positioned in such a way that the 3D lens 806 is positioned outside the path of light. Further, the movement of the frame 804 may be actuated by an actuator (not shown) in a similar manner explained above.

In one example, multiple light emitting unit 800 may be used to form a display panel similar to the display 400. Further, the light emitting unit 800 is a replaceable component with other light emitting units 800 in the display panel. In other word, in case where one or more light emitting unit 800 malfunctions or does not work, then the defective light emitting unit 800 can be replaced without replacing the display panel.

Although aspects for methods and systems for resolving issues have been described in a language specific to structural features and/or methods, the present subject is not necessarily limited to the specific features or methods described. Rather, the specific features and methods are disclosed as examples for resolving the issue.

I/We claim:

1. A user device for selectively rendering three-dimensional (3D) content comprising:
a light emitting panel to emit light; and
a 3D panel positioned adjacent to the light emitting panel, the 3D panel including a plurality of 3D lenses, the 3D panel being selectively positionable with respect to the light emitting panel between a first position and a second position, wherein, in the first position, the plurality of 3D lenses are positioned in a path of emitted light and, in the second position, the plurality of 3D lenses are positioned outside the path of emitted light.

2. The user device as claimed in claim 1 further comprising an actuator to selectively position each of the plurality of 3D lenses.

3. The user device as claimed in claim 2 further comprising a switch to operate the actuator.

4. The user device as claimed in claim 1, wherein the light emitting panel is a single light source.

5. The user device as claimed in claim 1, wherein the light emitting panel is made of a plurality of light sources.

6. The user device as claimed in claim 1, wherein the light emitting panel includes micro-light emitting diode.

7. The user device as claimed in claim 1, wherein the each of the plurality of 3D lenses is a lenticular lens.

8. A display for selectively rendering three-dimensional (3D) content comprising:
a set of light sources to emit light;
a frame selectively positionable with respect to the set of light sources, the frame comprising a 3D lens mounted thereon, wherein the frame is positionable in a first position to bring the 3D lens in a path of light emitted from the set of light sources and is positionable in a second position to bring the 3D lens outside the path of light; and
an actuator to selectively position the frame in the first position and the second position.

9. The display as claimed in claim 8, wherein the set of light sources and the frame are coaxially positioned with respect to each other.

10. The display as claimed in claim 8, wherein the actuator is coupled to the frame by a driving mechanism.

11. The display as claimed in claim 8, wherein the set of light sources includes one of a single light source and a plurality of light sources.

12. The display as claimed in claim 8, wherein the set of light sources is one of a LED (light emitting diode) unit, OLED (organic light emitting diode) unit, and μLED unit (micro-light emitting diode).

13. The display as claimed in claim 8, wherein the 3D lens is a lenticular lens.

14. A light emitting unit for selectively rendering three-dimensional (3D) content comprising:
a micro-light emitting diode (μLED) unit to emit light; and
a frame movably coupled to the μLED unit to be rotatable with respect to the μLED unit, the frame comprising a 3D lens mounted thereon selectively positionable with respect to the μLED unit, wherein the frame is movable to a first position to bring the 3D lens in a path of light emitted from the μLED unit and, wherein the frame is movable to a second position to bring the 3D lens outside the path of light.

15. The light emitting unit as claimed in claim 14, wherein the 3D lens is a lenticular lens.
